(19) United States
(12) Patent Application Publication
(10) Pub. No.: US 2022/0357975 A1
(43) Pub. Date: Nov. 10, 2022

(54) OPTIMIZATIONS FOR VIRTUAL ENVIRONMENT EXECUTION IN A NETWORK

(71) Applicant: Intel Corporation, Santa Clara, CA (US)

(72) Inventors: Haibin Huang, Hangzhou (CN); Xinyu Huang, Shanghai (CN); Qiaowei Ren, Shanghai (CN); Ruoyu Ying, Shanghai (CN)

(73) Assignee: Intel Corporation, Santa Clara, CA (US)

(21) Appl. No.: 17/868,408

(22) Filed: Jul. 19, 2022

(30) Foreign Application Priority Data
Jun. 20, 2022 (CN) PCT/CN2022/099778

(51) Int. Cl. G06F 9/455

(52) U.S. Cl. CPC G06F 9/45558; G06F 9/45545; G06F 2009/4557; G06F 2009/45583; G06F 2009/45595

(57) ABSTRACT

In one embodiment, a request is sent to an image registry for at least one virtual environment image block of an image for a virtual environment. The at least one virtual environment image block is processed upon reception of the at least one virtual environment image block from the image registry. The processed at least one virtual environment image block is communicated to a worker node that is to execute the virtual environment.

### CROSS-REFERENCE TO RELATED APPLICATION

This application claims the benefit of International Application No. PCT/CN2022/099778, filed Jun. 20, 2022.

### BACKGROUND

Web services today are typically deployed using Cloud Service Providers (CSPs) and are built using multiple microservices, or small software application instances. Microservices communicate with each other to realize desired business logic. To deploy, scale and provide fault tolerance, an orchestrator may be used to form a cluster of the selected infrastructure nodes for the web service.

### BRIEF DESCRIPTION OF THE DRAWINGS

FIG. 1 illustrates an example system implementing a container orchestration framework in accordance with embodiments of the present disclosure.

FIGS. 2A-2B illustrate example container deployments on worker nodes in accordance with embodiments of the present disclosure.

FIG. 3 illustrates an example architecture for distributing image blocks for container startup in accordance with embodiments of the present disclosure.

FIG. 4 illustrates an example method for distributing image blocks for container startup in accordance with embodiments of the present disclosure.

FIG. 5 illustrates an example architecture for optimizing container placement in accordance with embodiments of the present disclosure.

FIG. 6 illustrates an example method for optimizing container placement in accordance with embodiments of the present disclosure.

FIGS. 7-8 illustrate deployment and orchestration for virtual edge configurations across an edge computing system operated among multiple edge nodes and multiple tenants.

FIG. 9 illustrates various compute arrangements deploying containers in an edge computing system.

FIG. 10 illustrates an example embodiment of a computing platform.

### EMBODIMENTS OF THE DISCLOSURE

Web services are typically deployed using Cloud Service Providers (CSPs) and are built using multiple microservices, or small software application instances. Microservices communicate with each other to realize the desired business logic. To deploy, scale and provide fault tolerance, an orchestrator may be used to form a cluster of the selected infrastructure nodes for the web service. The microservices may be developed as part of a modular architecture and deployed as containers using an orchestration framework, e.g., Docker® and/or Kubernetes®. As used herein, “microservice” may refer to an application instance deployed on a node, e.g., inside a container of a node. In some instances, the node may implement a virtual machine inside which the microservice is deployed, e.g., within a container on the virtual machine. In some cases, a microservice may also be referred to as a workload.

Although the description below focuses on containers, the embodiments described herein may also be applied to virtual machines. Thus, any reference below to a container may alternatively refer to a virtual machine (where appropriate). Thus, use of the term “virtual environment” herein may refer to a container, a virtual machine, or the like.

Containers may run software applications, e.g., microservices, within isolated runtime environments while sharing the same operating system (OS) kernel on a node. For example, each container on a node may be an isolated user-space instance that can be used to run one or more software applications (e.g., microservices), and multiple containers for different software applications can be instantiated on the same OS kernel. In this manner, software applications in different containers can share the same OS kernel while remaining isolated from each other. Moreover, each container is typically instantiated from a corresponding container image that bundles a particular software application with all of its dependencies (e.g., application(s), tools, libraries, configuration files, and so forth), thus ensuring that the software application runs out-of-the-box on any machine running the appropriate operating system. In some instances, groups of one or more containers may be referred to as “pods” (e.g., in) Kubernetes®.

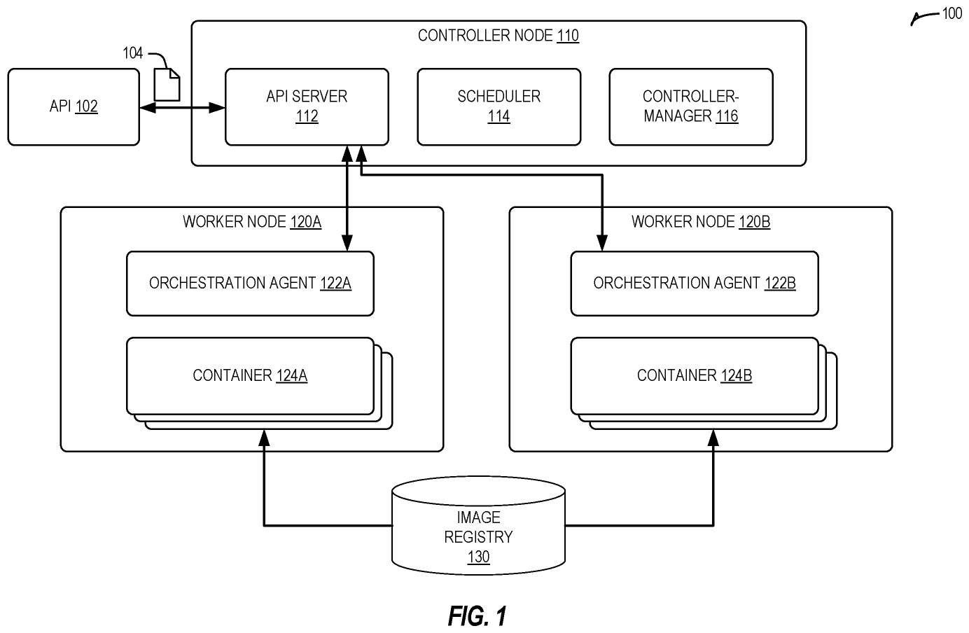

FIG. 1 illustrates an example system 100 implementing a container orchestration framework in accordance with embodiments of the present disclosure. In some embodiments, the system 100 may be considered as a system that provides “cloud services”. The system 100 includes a controller node 110 and multiple worker nodes 120. The controller node 110 is responsible for orchestration and deployment decisions for the worker nodes 120 and is the interface to an entity (e.g., developer, customer, or other user) deploying workloads via an application programming interface (API) 102 (e.g., using kubectl in)Kubernetes®. Workloads are executed via containers 124 on the worker nodes 120. The worker nodes 120 each run an orchestration agent 122 (e.g., a kubelet in Kubernetes®) that provides general access to common infrastructure of the worker node 120 or the cloud service provider, such as remote workload stores (e.g., image registry 130) or other storage. The orchestration agent 122 may deploy the containers 124 based on, e.g., container images stored in the image registry 130. In some instances, the orchestration agent 122 may run one or more containers 124 in a group sometimes referred to as a “pod”. The orchestration agent 122 may also provide information to the controller node 110 about the execution of the containers 124 on the worker node 120, e.g., telemetry or other data.

The image registry 130 includes a repository used to store and access container images. In some embodiments, the image registry is a stateless, highly scalable server side application that stores and distributes images. For example, the image registry 130 may include a Docker Registry. In some embodiments, an image registry may store other data, such as API paths and access control parameters for communications between containers. As depicted, the image registry 130 may be accessible by the worker nodes 120 (e.g., either directly or through one or more intermediate network devices).

A container image may comprise a file with executable code that can create a container on a computing system. A container image may include sufficient files (e.g., binaries, source code, other dependencies needed to deploy the container) to allow the container to be executed on a computing system (e.g., a worker node). For example, the container image may include one or more of a container engine, system libraries, utilities, configuration settings, or specific workloads to run on the container.

A container image may comprise one or more layers, and a layer may comprise one or more image blocks (e.g., data blocks). An image layer may store the changes compared to the image it is based on (which itself may be a collection of layers). In some examples, a container image may be built off of an existing image (referred to as a base image or parent image) and may include one or more layers added to the existing image. In various embodiments, the majority of the layers may be immutable so that the image can be reused to create any number of instances of the container. However, the image may also include a read-write layer that may be used for various purposes (e.g., file changes, file additions, or file deletions). A container image may also include a manifest file that describes the image and includes metadata, such as tags, a digital signature to verify the origin of the container image, or documentation associated with the image.

The controller node 110 includes an API server 112 that receives API commands from and otherwise interfaces with developers or other users deploying workloads in the system 100. For instance, the API server 112 may expose an API for the orchestration framework (e.g., Kubernetes®), which may be the front end for the control plane of the orchestration framework. The controller node 110 also includes a scheduler 114 that selects a worker node 120 on which to deploy a container 124. The scheduler may take into account collocation, microservice quality of service (QoS), security needs, and/or other factors when making a deployment decision for a container 124. The controller node 110 also includes a controller-manager 116 that runs controller processes, such as node controllers or job/service controllers, and/or provides cloud-specific controls to developers.

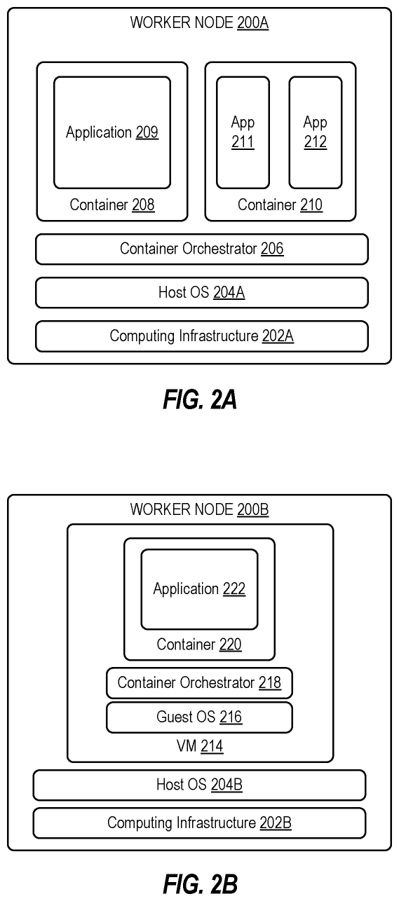

FIGS. 2A-2B illustrate example container deployments on worker nodes 200 in accordance with embodiments of the present disclosure. In particular, FIG. 2A illustrates a container-only deployment on the worker node 200A, while FIG. 2B illustrates a container deployment within a virtual machine executing on the worker node 200B. In each example, the worker node 120 includes a computing infrastructure 202 and a host operating system (OS) 204 executing on the infrastructure 202. The computing infrastructure 202 can include the processing, memory, storage, and other computational resources of the worker node 200, and the host operating system (OS) 204 can include any suitable operating system (e.g., Linux) running on the computing infrastructure 202. In some embodiments, each worker node 120 may be deployed on a distinct computing device (e.g., a server computer).

Each depicted example also includes a container orchestrator (e.g., 206, 218) and containers (e.g., 208, 210, 220). The container orchestrator is responsible for creating and orchestrating the containers across the underlying computing infrastructure, which may include actual underlying computing infrastructure 202 (e.g., in FIG. 2A) or a virtualized/abstracted version of the underlying computing infrastructure 202 (e.g., as in FIG. 2B). In some embodiments, for example, the container orchestrator may be implemented using Docker Swarm, Kubernetes, HashiCorp Nomad, and/or any other suitable container orchestration service. In the example shown in FIG. 2A, the container orchestrator 206 is running two containers 208 and 210. Container 208 is running an application 209 on the host OS 204A, while container 210 is running two applications 211, 212 on the host OS 204A. In the example shown in FIG. 2B, the container orchestrator 218 is running a container 220 on a guest OS 216 running on a virtual machine 214, which is running on the host OS 204B.

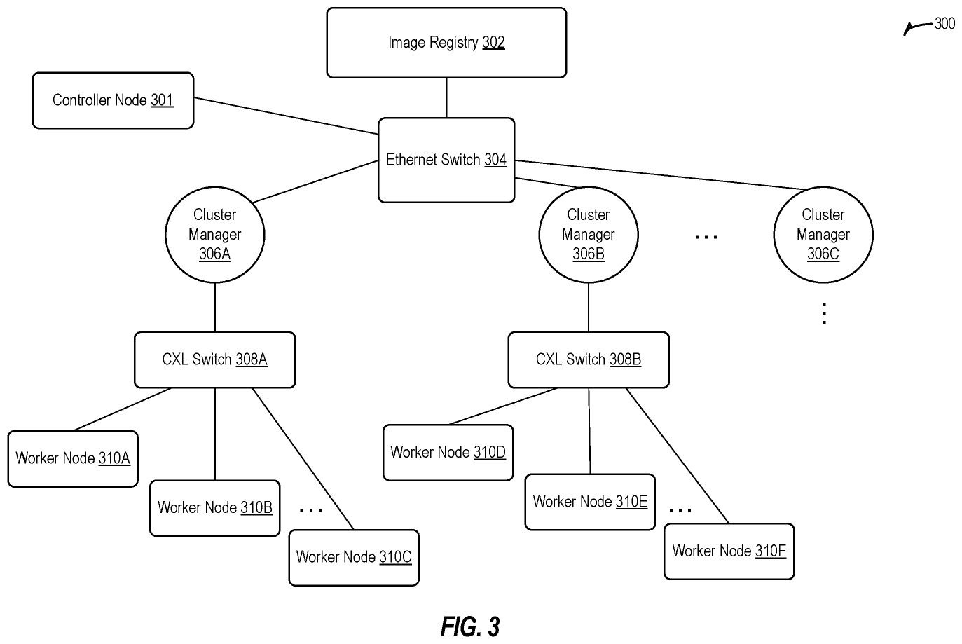

FIG. 3 illustrates an example architecture for distributing image blocks for container startup in accordance with embodiments of the present disclosure. System 300 comprises an image registry 302, a controller node 301, cluster managers 306, and worker nodes 310 to run a plurality of containers. Various components of system 300 are coupled together by networking components, such as Ethernet switch 304, and Compute Express Link (CXL) switches 308 (e.g., 308A and 308B). In other embodiments, other suitable coupling arrangements for the components may be used. Controller node 301 may have any suitable characteristics of controller node 110, worker nodes 310 may have any suitable characteristics of worker nodes 120 or 200, and image registry 302 may have any suitable characteristics of image registry 130.

There are many scenarios (e.g., when the system 300 provides function as a service (FaaS) capabilities) in which multiple containers should be started quickly and securely. However, the process of image distribution to the appropriate worker nodes to allow the worker nodes to start up the corresponding containers may take a large amount of time due to large image size and the number of copies to be distributed, potentially causing long latencies. Moreover, in order to provide integrity and confidentiality, a cyclic redundancy check (CRC) and encryption/decryption operations may be performed (e.g., by a cryptographic accelerator or other suitable circuitry) on image blocks that are pulled by the worker nodes from the image registry 302 (as the image blocks may be encrypted (e.g., by a cryptographic accelerator or other suitable circuitry) and/or compressed in the registry), utilizing a large amount of processing cycles (e.g., central processor unit (CPU) cycles) of the worker nodes. Prefetching image blocks from the image registry to the worker nodes may help reduce the latencies, but may be resource intensive for the worker nodes.

In the embodiment depicted, cluster managers 306 are coupled to (e.g., between) worker nodes 310 and the image registry 302. In the depicted example, a cluster manager 306 (e.g., 306A) may be coupled to respective worker nodes 310 (e.g., 310A, 3106, 310C) through CXL switch 308 (e.g., 308A). The cluster managers 306 are coupled to the image registry 302 through Ethernet switch 304.

Various operations associated with starting containers may be offloaded to the cluster managers 306. Such operations may include, e.g., CRC calculations (e.g., a CRC32 function performed on one or more image blocks to determine whether the respective image blocks were changed during transit, e.g., from the image registry 302 to the cluster manager 306), image block decompressions, and image block decryptions. The decompressed and decrypted image blocks may be stored by the cluster manager 306 and the worker nodes 310 may then fetch the necessary image blocks from a respective cluster manager 306 when starting a container, thus reducing the latency (and processing cycles expended by a worker node 310) relative to fetching the image blocks from an image registry 302. Image blocks may be prefetched by the cluster managers 306 and stored into memory of the cluster managers for faster communication of image blocks to the worker nodes 310. Extensibility of the memory of the cluster manager 306 (for example, a cluster manager 306 may extend its memory size using CXL) may provide flexibility for the image prefetching scheme.

In some embodiments, after a cluster manager 306 fetches encrypted and/or compressed image blocks from the image registry 302 and decrypts (e.g., by a cryptographic accelerator of the cluster manager 306 or other suitable circuitry) and/or decompresses the image blocks, the cluster manager 306 may store the image blocks in an unencrypted and/or decompressed format. The image blocks may be protected (e.g., with one or more of confidentiality, integrity, or replay protection) in transit to the worker nodes 310 by a communication protocol used by the worker nodes 310 and the cluster manager 306. In some embodiments, this communication protocol is CXL. CXL is a high performance I/O bus architecture used to interconnect peripheral devices such as traditional non-coherent 10 devices, memory devices, or accelerators with additional capabilities. CXL may provide a way for a host device and a CXL device connected to the host device to execute push/pull operands on memories from each side without adding significant software and hardware costs.

CXL may include a built-in integrity and data encryption (IDE) mechanism that provides confidentiality, integrity, and replay protection for data transiting the CXL link. CXL IDE includes both CXL.io IDE and CXL.cachemem IDE. CXL.io IDE follows the PCIE IDE definition to provide security for link and transaction layer packets (TLP). CXL.cachemem IDE provides IDE for communications with the cache or memory within a device. The IDE used in CXL includes a programmable cyclic redundancy check (PCRC) mechanism and uses the Advanced Encryption Standard-Galois Counter (AES-GCM) mode of operation to encrypt data within the transmission. Thus, integrity and confidentiality are provided for data transmitted using CXL.

A cluster manager and its worker nodes are connected through a CXL switch, which provides both confidentiality and integrity for the data transmission between the channels. CXL assures the security between a cluster manager 306 and its worker nodes 310, so that no extra compressions and encryptions are needed.

Although various embodiments describe and depict the CXL protocol and CXL compliant networking devices (e.g., CXL switches) for communication between system components, any other suitable protocols and networking devices compliant with the protocols may be used in other embodiments. Any suitable protocol may be used, such as any protocol that provides high speed transfer and/or can protect the data in transit. For example, in one embodiment, a CCIX® protocol may be used (e.g., to communicate the image blocks from the cluster managers to the worker nodes or to communicate between worker nodes). In other embodiments, a Peripheral Component Interconnect Express (PCIx) protocol, Universal Serial Bus (USB) protocol, or other suitable protocols may be used.

Image prefetching may proceed as follows. The prefetching may be performed by a cluster manager 306 at any suitable time, for example, prefetching may be initiated when a cluster manager boots. In various embodiments, the prefetching may be based, e.g., on a list (e.g., of images) provided by an orchestration manager (e.g., controller node 301). For example, the orchestration manager may generate the list based on workloads to be run (or expected to be run) on the worker nodes of the particular cluster manager (e.g., worker nodes connected to the cluster manager through a single switch or through a network of switches or other networking elements). In various embodiments, prefetching may additionally or alternatively be based on a history of containers run on worker nodes of the cluster manager 306. The history may be stored by the cluster manager or an orchestration manager (e.g., controller node 301). In some embodiments, identifications of the images to be prefetched may be communicated from the controller node 301 to the cluster managers 306 so the cluster managers 306 may then prefetch the images from the image registry 302.

In one example, a cluster manager 306A may receive (e.g., from the controller node 301) an image list identifying one or more container images to be prefetched. For each image in the image list, the cluster manager 306A may fetch a trace file associated with (or that is stored as part of) the image from the image registry 302. A trace file may be included within an image as a special image layer. The trace file may indicate the sequence of image blocks that are used to start the container (in some instances the image may include additional image blocks which are associated with or part of the container, but not needed to start the container) as well as the location for each image block. In one example, a trace may be collected using blktrace and replayed with fio.

For each image to be prefetched, the cluster manager 306A will pull the image blocks listed in the corresponding trace file from the image registry 302. The cluster manager 306A may then perform CRC calculations on the image blocks (e.g., on each image block and/or on groups of image blocks) to ensure that the image blocks transferred from the image registry 302 to the cluster manager 306A are valid (e.g., have not changed during transit). The cluster manager may also perform decryption or decompression of the image blocks to obtain the plaintext image blocks. These plaintext image blocks are then stored into memory of the cluster manager 306A.

In some embodiments, during runtime, if at least a portion of an image that has not been prefetched by cluster manager 306A is requested by one of its worker nodes (e.g., after the worker node determines that the image is not stored in memory of the worker node), the cluster manager 306A will fetch the trace file of that image from the image registry 302, and then check whether the image blocks that are needed to start the container are stored in memory of any of the other associated cluster managers 306 (e.g., 306B, 306C) (e.g., cluster managers that are coupled to the same Ethernet switch 304 as the cluster manager 306A). If the image blocks are stored by another cluster manager 306, a cross-fetching strategy may be used to obtain the image blocks in plaintext from that cluster manager. For example, if cluster manager 306A does not have a requested image block stored in its memory, it may pull the image block from cluster manager 306B and then return the image block to the requesting worker node 310. If the image blocks are not stored by another cluster manager 306, then the cluster manager 306A may follow the same process as described above with respect to prefetching in order to obtain the image blocks from the image registry 302 and to extract the image blocks.

In other embodiments, during runtime, if at least a portion of an image that has not been prefetched to a cluster manager 306A is requested by one of its worker nodes, the cluster manager 306A will fetch the trace file of that image from the image registry 302 and then fetch the image blocks needed to start the container form the image registry 302 directly without checking with one or more other cluster managers first.

Responsive to a trigger (e.g., associated with a cluster manager 306A fetching at least a portion of an image), a cluster manager 306A may send a notification to one or more (e.g., all) of its neighbor cluster managers (e.g., 306B or 306C) with an identification of the image. Any suitable trigger may be used, such as a request received at the cluster manager 306A from a worker node 310 for an image or a portion thereof, the reception at cluster manager 306A of an identification of an image (e.g., received from controller node 301), the reception at cluster manager 306A of one or more portions of the image from image registry 302, or other suitable trigger.

Responsive to this notification, a neighbor cluster manager 306 may prefetch the image to prepare for potential requests for its worker nodes to execute the container corresponding to the image. For example, the neighbor cluster manager 306 may either pull the plaintext image from the cluster manager 306A that sent the notification or the neighbor cluster manager 306 may pull the image from the image registry 302 and perform CRC operations, decompression, and/or decryption of the image and then store the plaintext image in memory of the neighbor cluster manager.

The designation of cluster managers 306 as neighbor cluster mangers may occur at any suitable time. For example, a neighbor cluster manager of cluster manager 306A may be a cluster manager that is associated with the cluster manager 306A in any suitable manner. For example, neighbor cluster managers of a cluster manager may be the cluster managers that are connected to the same switch (e.g., Ethernet switch 304) as the cluster manager.

In various embodiments, neighbor cluster managers may be defined during a bootstrap stage (e.g., during the bootstrap stage, the cluster managers 306 and the network that connects them may be set up, the neighbor relationships may be defined, and the image list may be obtained from the orchestration manager to prepare for prefetching).

In one example, all cluster managers 306 that are connected to the same Ethernet switch 304 may form a connected graph and the connection time between each two cluster managers may be defined as the “distance” between the cluster managers. In one embodiment, the relationships of cluster managers as neighbor cluster managers may be based at least in part on execution of the Prim algorithm to create a minimum spanning tree.

In some embodiments, a cross-fetching strategy may be used in which a cluster manager 306A may pull one or more image blocks from one of its neighbor cluster managers without having to pull the image blocks from the image registry 302. As the neighbor cluster manager may have already performed one or more of CRC operations, decryption, and/or decompression of the image blocks, the requesting cluster manager may omit such operations when pulling the image blocks from a neighbor cluster manager.

In one embodiment, a cluster manager may track the image blocks that are stored by its neighbor cluster managers in order to facilitate quick retrieval of the image blocks. For example, a cluster manager may track the image blocks based at least in part on received notifications from its neighbor cluster managers when the neighbor cluster managers pull images from the image registry 302. As another example, a cluster manager may track the image blocks based on messages provided by a controller node 301 or an image registry 302 indicating which cluster managers have received which images. In other embodiments, a cluster manager may omit tracking of the locations of the image blocks among the other cluster managers and may simply send a request (e.g., a broadcast request) to one or more of the neighbor cluster managers identifying the requested image blocks. The one or more neighbor cluster managers may respond with an indication of whether the image blocks are stored by the respective cluster managers. The cluster manager may then request the image blocks from one of the neighbor cluster managers. Alternatively, a neighbor cluster manager could respond with the requested image blocks.

In some embodiments, during the initial image prefetching stage, a cross-fetching strategy can be used in which a controller node 301 distributes images to be prefetched among two or more neighbor cluster managers. For example, the controller node 301 may distribute multiple images for containers that are going to be executed by worker nodes of two different cluster managers 306 among those cluster managers (e.g., a first cluster manager may be directed to prefetch a first image for a container that is to be run by a worker node of a second cluster manager and/or the second cluster manager may be directed to prefetch a second image for a container that is to be run by a worker node of the first cluster manager. In such a manner, the images may be obtained by the worker nodes from the various cluster managers 306 without accessing the image registry 302, while reducing the storage requirements at each cluster manager 306. Thus, in some embodiments, in order to effectuate efficient cross-fetching, the initial pre-fetching stage may be coordinated among the cluster managers 306 so that different images (or different image layers of the same image) are prefetched by different cluster managers 306.

Image usage may proceed as follows. When a worker node 310 starts up a container (e.g., responsive to direction from controller node 301), the worker node may check whether the image blocks needed to start the container are stored in a local memory of the worker node 310. If the image blocks are stored in its local memory, the worker node 310 will use the image blocks to start the container.

If the image blocks are not stored in the local memory of the worker node, then the worker node 310 may access the memory of its cluster manager 306 through a switch (e.g., CXL switch 308). If the image blocks are found in the memory of the cluster manager 306, then the worker node 310 will copy the plaintext image blocks from the cluster manager 306 to local memory of the worker node 310 and will start the container. In various embodiments, when an image block is transferred from the cluster manager 306 to the worker node 310, a communication protocol that (e.g., a CXL protocol) may be used to encrypt the image block in transit. The worker node 310 may then use the communication protocol to decrypt the image block based before storing the image block in local memory.

If the image blocks are not stored in the memory of the cluster manager 306, then the worker node 310 may send a request to the cluster manager 306 to fetch the image blocks (alternatively, the cluster manager may determine to fetch these blocks responsive to a determination that it doesn't have these blocks stored when the initial request is received from the worker node).

In some embodiments, before pulling the image blocks from the image registry 302, the cluster manager will first determine whether any of its neighbor cluster managers 306 have the image blocks stored in their memories. If a neighbor cluster manager 306 has the image blocks stored, then the cluster manager 306 will retrieve the image blocks from the neighbor cluster manager. In various embodiments, the retrieved image blocks may be stored in plaintext by the neighbor cluster manager (as the neighbor cluster manager may have already performed CRC, decryption, and/or decompression operations on the image blocks when the neighbor cluster manager pulled the image blocks from the image registry 302). When an image block is transferred from the neighbor cluster manager to the cluster manager, a communication protocol (e.g., a CXL protocol) may be used to encrypt the image block in transit.

If no neighbor cluster manager has stored the image blocks, then the cluster manager may pull the image blocks from the image registry 302. In alternative embodiments, when the cluster manager does not have the image blocks stored, it may request the image blocks directly from the image registry 302 without communicating with its neighbor cluster managers.

If the image blocks are pulled from the image registry 302, the cluster manager may also perform CRC calculations to verify that the image blocks sent by the image registry 302 match the image blocks received at the cluster manager 306. The cluster manager may also decrypt and/or decompress the image blocks to generate pre-processed image blocks in plaintext form. Such processing operations may be performed after the image blocks have been processed according to whatever communication protocol (e.g., an Ethernet protocol or other suitable communication protocol) was used to transfer the image blocks over the network between the image registry 302 and the cluster manager. Thus, the processing operations may be performed on versions of the image blocks that are the same as the versions stored at the image registry 302 (assuming the image blocks were transferred without error).

The image blocks will then be stored into memory of the cluster manager according to the trace file (e.g., in an order based on the trace file). The worker node 310 may then copy the image blocks from the memory of the cluster manager to its local memory through a communication protocol that supports encryption (e.g., a CXL protocol). The worker node may then load the image blocks in order to start the container. If additional image blocks are to be used for the startup of the container, the request process may be repeated.

When a different worker node coupled to the same cluster manager starts up the same container, it will be able to copy the image blocks quickly from the memory of the cluster manager, thus accelerating the container startup process. For example, if worker node 310A originally requested the image blocks and the image blocks were pulled to cluster manager 306A as a result, worker node 310B will be able to obtain the plaintext image blocks from cluster manager 306A very quickly (while the transfer of the image blocks from the cluster manager 306A to worker node 310B may also be protected via the same protocol used to transfer the blocks to worker node 310A).

In some embodiments, a worker node may run a container as well as an image service. When requesting an image, a container may send out a request with the image url. The image service (running on the same worker node) may intercept the request and request the image trace file instead of the entire image. After the trace file is received and saved locally at the worker node, the image service may request certain image blocks based on the trace file for the image and may return the responses to the container (in at least some embodiments, the cluster manager 306 may service these requests). The returned image blocks may then be provided from the image service to the container.

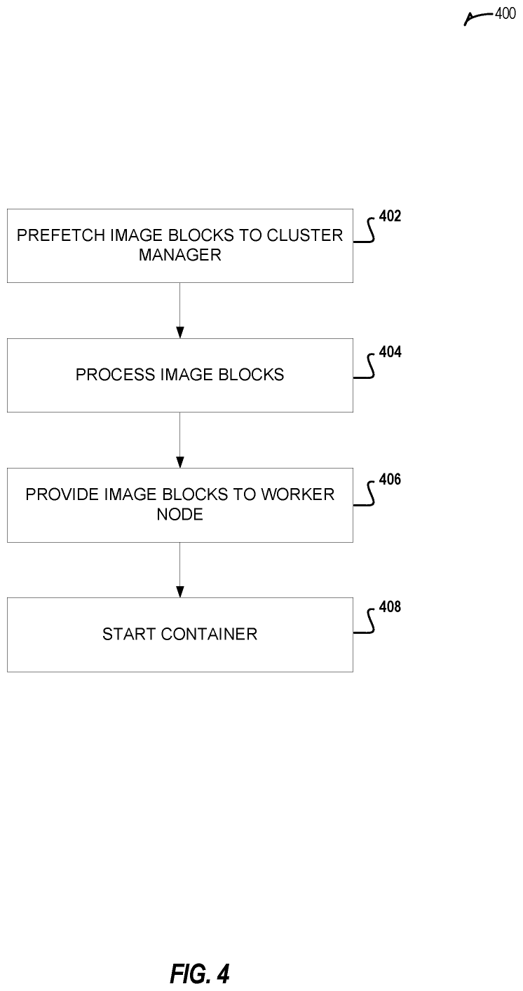

FIG. 4 illustrates an example method for distributing image blocks for container startup in accordance with embodiments of the present disclosure. At 402, image blocks are prefetched to a cluster manager. At 404 the image blocks are processed (e.g., CRC operations completed, decrypted, and/or decompressed) by the cluster manager. At 406, the image blocks are provided by the cluster manager to a worker node. At 408, the worker node, starts a container using the image blocks.

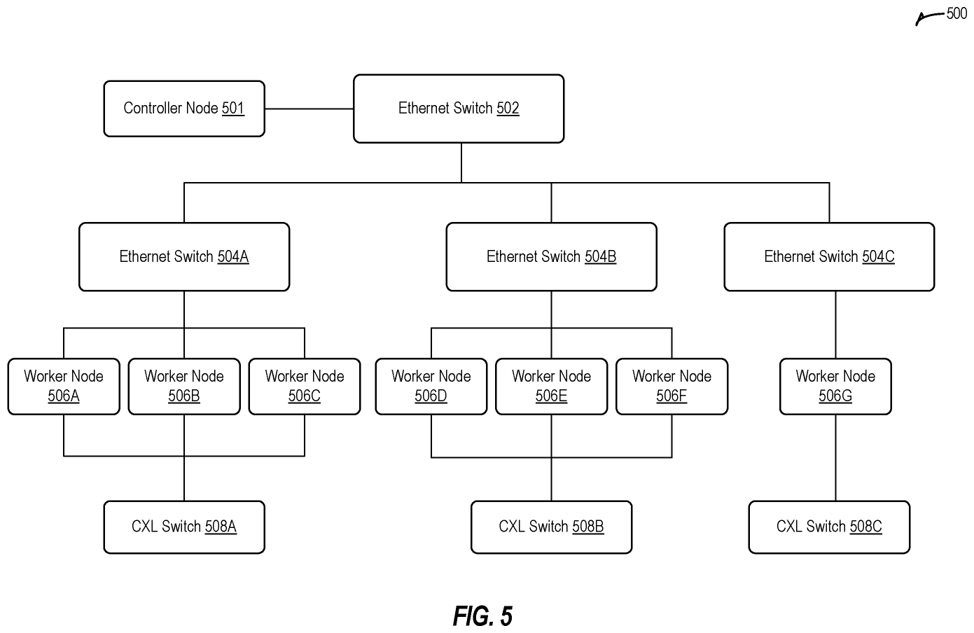

FIG. 5 illustrates an example architecture for optimizing container placement in accordance with embodiments of the present disclosure. FIG. 5 illustrates a container call domain 500. A container call domain may include any suitable collection of worker nodes 506, such as a Kubernetes (K8s) cluster.

Call domain 500 comprises a controller node 501 coupled via a plurality of switches (e.g., Ethernet switches 502 and 504) to a plurality of worker nodes 506. Various sets of worker nodes are also coupled together by other switches (e.g., CXL switches 508). In other arrangements, the components of the call domain may be coupled together using other suitable networking components.

Controller node 501 may have any suitable characteristics of controller node 110 or 301 and worker nodes 506 may have any suitable characteristics of worker nodes 120, 200, or 310. The call domain may include other computing systems that are not shown (e.g., an image registry, one or more cluster managers, or other suitable systems).

Conventional container scheduling methods generally consider the performance maximization of a single container, without considering the overall collaborative performance optimization. However, when two containers communicate a large amount of data traffic between them, but the network distance between the two containers is very far away or the location of shared resources is very far away, such scheduling methods may not be optimal for the cooperation between the containers.

When collaborative containers are deployed together in a static configuration, the system does not adapt to changes in data patterns (e.g., when traffic between containers is not constant, when traffic between two containers suddenly becomes large, etc.). Thus, the communication delay may be unduly large if traffic increases but the worker nodes are separated by a large distance. With some interconnect technologies, containers can share data through the network as well as through shared memory and other means, which may exacerbate inefficient scheduling issues.

Various embodiments of the present disclosure provide a method for considering the overall performance optimization of a container in determining where to place the container in the network. The location of the container may be changed from time to time based on dynamic network conditions. In various embodiments, a score for the container's current location is determined based in in part on the traffic within a container's call domain and the traffic distances between the container and other containers with which the container is communicating. Scores for other potential locations for the container may also be calculated in order to find the worker node at which the score for the container is maximized and the container may be moved to that worker node.

The scores may be calculated by any suitable entity. For example, the controller node 501 may calculate the scores. As another example, a traffic-controller in a call domain may be used to calculate the scores. In one embodiment, the traffic-controller may use a webhook for an API server and use a custom resource (CRD) to calculate the scores.

Various embodiments may mitigate data sharing delays between containers due to bursts of traffic between containers. When traffic spikes occur, the system may reduce the network overhead between containers in order to keep operations running smoothly.

The architecture shown in FIG. 5 may be used in any suitable environment, such as a data center. In the embodiment depicted, there are two types of links between the worker nodes 506. The control plane may use a relatively low-speed connection (e.g., an Ethernet connection that runs through Ethernet switches 504 and Ethernet switch 502) and the data plane may use a higher-speed connection (e.g., a CXL 2.0 connection or other suitable high speed connection). Various embodiments herein are directed to high-speed data sharing over the data plane.

A container call domain 500 may be organized into a multi-level traffic domain wherein the different levels of domains may be used to identify the distance between two containers. One example of a multi-level domain includes the following levels:

Level 1: Containers located in the same non-uniform memory access (NUMA) domain on the same worker node (e.g., server)

Level 2: Containers not in the same NUMA domain, but still on the same worker node (e.g., server)

Level 3: Containers on different worker nodes 506 connected to the same high speed switch (e.g., CXL switch 508)

Level 4: Containers on different worker nodes 506 that are not connected to the same high speed switch but are connected to the same low speed switch (e.g., Ethernet switch 504) with a port bandwidth above a first threshold (e.g., >100 Gb/s)

Level 5: Containers on different worker nodes 506 that are not connected to the same high speed switch but are connected to the same low speed switch (e.g., Ethernet switch 504) with a port bandwidth between the first threshold and a second threshold (e.g., between 10 Gb/s and 100 Gb/s)

Level 6: Containers on different worker nodes 506 that are not connected to the same high speed switch but are connected to the same low speed switch (e.g., Ethernet switch 504) with a port bandwidth between the second threshold and a third threshold (e.g., between 1 Gb/s and 10 Gb/s)

Level 7: Containers on different worker nodes 506 that are not connected to same high speed switch but are connected to the same low speed switch (e.g., Ethernet switch 504) with a port bandwidth lower than the third threshold (e.g., <1 Gb/s)

The score of a container may be based on the distances between that container and the containers with which it communicates as well as characteristics of the communication between the container and these other containers. A higher score indicates that the current container location is appropriate. In one embodiment, the score may be calculated as follows:

$${Score}_{i} = {\sum }_{j ∈ C} \frac{{flow}_{i , j} * {weight}_{i , j} * {frequency}_{i , j}}{{distance}_{i , j}}$$

The Scoreᵢ refers to the traffic performance value between container i and all other containers in a container call domain (where C refers to the collection of all containers j except container i).

flow_{i,j} refers to the flow rate (e.g., in bytes/second) at which containers i and j are communicating with each other.

weight_{i,j} refers to the importance of the flow between container i and container j. In some embodiments, the weight term could be omitted from the score calculation (e.g., the flows may all be assigned the same weight). The weights may be assigned to flows by any suitable entity. For example, a user that requests deployment of the containers of the flow may provide the relative weights of the flows between the containers (e.g., based on a business requirement).

frequency_{i,j} refers to the most recent communication frequency (e.g., in terms of communications/second) between container i and container j. In this sense, a communication may refer to a connection between containers through which one or more packets is transported and could involve channel setup and teardown (thus, each packet is not necessarily a distinct communication for purposes of calculating the frequency). One purpose of using the frequency in the score is to reduce frequent container switching.

The frequency as well as the flow rate may be measured over any suitable timespans (e.g., 1 hour, 10 minutes, etc.). In various embodiments, a user that requests deployment of the containers may set and/or modify the timespan. The timespan may be the same for the frequency and the flow.

distance_{i,j} refers to the difference in traffic domain between container i and container j. For example, using the distance scheme described above, the distance is 1 for containers in the first-level domain, the distance is 2 for containers in the second-level domain, and so on. In other embodiments, other distance scores may be assigned to the different domains in any suitable manner (and the difference in scores between domains does not need to be uniform). For example, the first level domain could correspond to a distance score of 1, the second level domain could correspond to a distance score of 1.5, the third level domain could correspond to a distance score of 4, etc.

The flow for optimizing the location of a container may proceed as follows. The flow may be performed periodically for any given container. The flow begins as a current score for the container (e.g., the score for the container at its current location) is calculated. A score is also calculated for each of at least one prospective location to which the container may be moved. In some embodiments, only the distance values change during the score calculation, so the numerator term for each container pair may be stored and reused in the calculations of the scores for the various locations.

In various embodiments, if the score for the current location is higher than any of the scores for the prospective locations, then the container location is not changed. However, if the current score is not the highest score of the scores calculated, then the container may be moved to the prospective location with the highest score. In some embodiments, if the highest score is not higher than the current score by a threshold amount, then the container may remain in its current location (e.g., the overhead associated with moving the container may mitigate the small benefit to be received from moving the container).

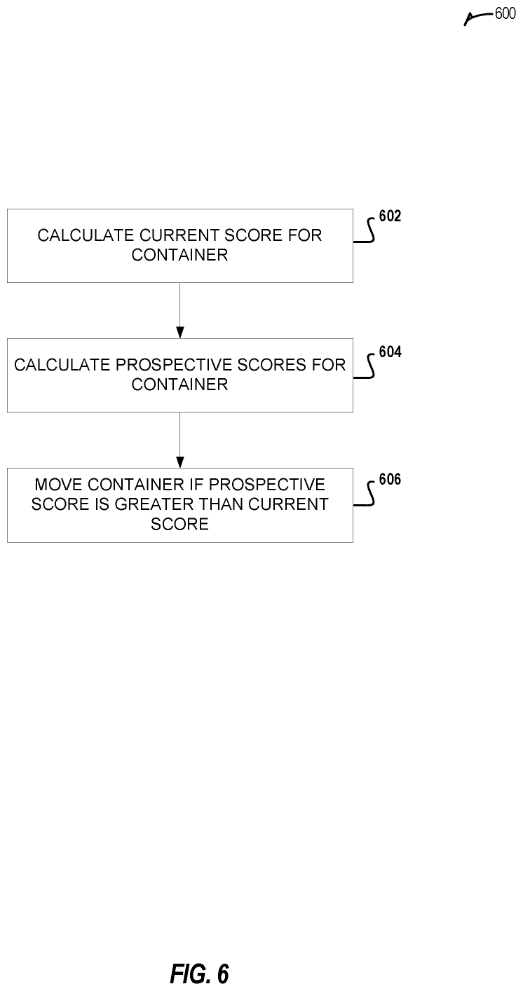

FIG. 6 illustrates an example method for optimizing container placement in accordance with embodiments of the present disclosure. At 602, a current score is calculated for a container. At 604, prospective scores for the container are calculated for prospective locations for the container. At 606, the container is moved if one of the prospective scores is higher than the current score.

The example method 600 may include additional or different operations, and the operations may be performed in the order shown or in another order. In some cases, one or more of the operations shown in FIG. 6 are implemented as processes that include multiple operations, sub-processes, or other types of routines. In some cases, operations can be combined, performed in another order, performed in parallel, iterated, or otherwise repeated or performed another manner.

The following sections present various examples of computing devices, systems, architectures, and environments that may be used to implement the architectures described throughout this disclosure. For example, any suitable components or group of components shown in the below FIGs. may be used to implement components described above (e.g., worker nodes, cluster managers, controller nodes, etc.).

The deployment of a multi-stakeholder edge computing system may be arranged and orchestrated to enable the deployment of multiple services and virtual edge instances, among multiple edge nodes and subsystems, for use by multiple tenants and service providers. In a system example applicable to a cloud service provider (CSP), the deployment of an edge computing system may be provided via an “over-the-top” approach, to introduce edge computing nodes as a supplemental tool to cloud computing. In a contrasting system example applicable to a telecommunications service provider (TSP), the deployment of an edge computing system may be provided via a “network-aggregation” approach, to introduce edge computing nodes at locations in which network accesses (from different types of data access networks) are aggregated. Moreover, these over-the-top and network aggregation approaches can also be implemented together in a hybrid or merged approach or configuration.

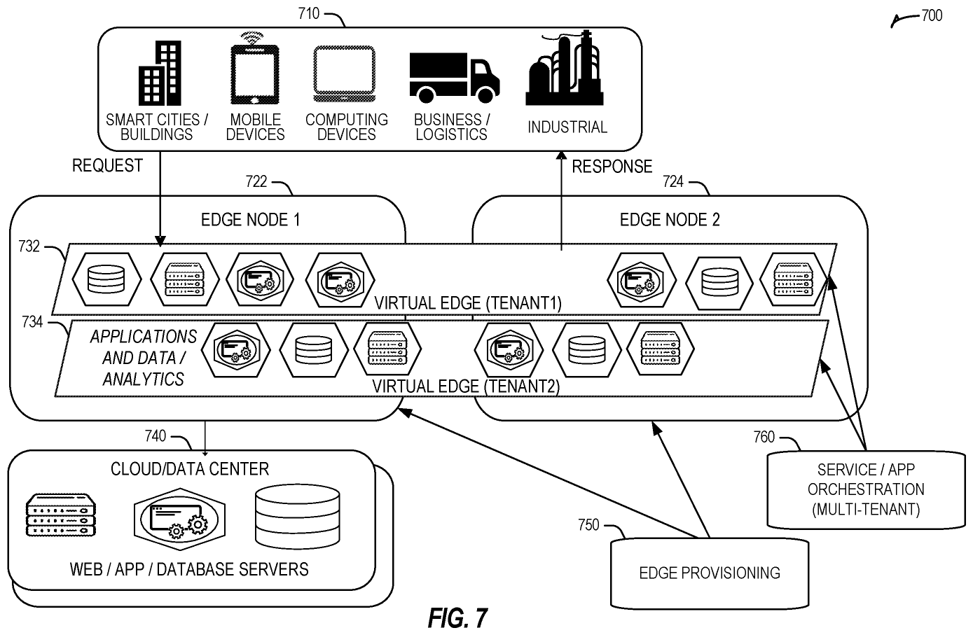

As an extension of either CSP or TSP configurations, FIGS. 7-10 illustrate deployment and orchestration for virtual edge configurations across an edge computing system operated among multiple edge nodes and multiple tenants. Specifically, FIG. 7 depicts coordination of a first edge node 722 and a second edge node 724 in an edge computing system 700, to fulfill requests and responses for various client endpoints 710 (e.g., smart cities/building systems, mobile devices, computing devices, business/logistics systems, industrial systems, etc.) which access various virtual edge instances. The virtual edge instances provide edge compute capabilities and processing in an edge cloud, with access to a cloud/data center 740 for higher-latency requests for websites, applications, database servers, etc. However, the edge cloud enables coordination of processing among multiple edge nodes for multiple tenants or entities.

In the example of FIG. 7, these virtual edge instances include: a first virtual edge 732, offered to a first tenant (Tenant 1), which offers a first combination of edge storage, computing, and services; and a second virtual edge 734, offering a second combination of edge storage, computing, and services. The virtual edge instances 732, 734 are distributed among the edge nodes 722, 724, and may include scenarios in which a request and response are fulfilled from the same or different edge nodes. The configuration of the edge nodes 722, 724 to operate in a distributed yet coordinated fashion occurs based on edge provisioning functions 750. The functionality of the edge nodes 722, 724 to provide coordinated operation for applications and services, among multiple tenants, occurs based on orchestration functions 760.

It should be understood that some of the devices in 710 are multi-tenant devices where Tenant 1 may function within a tenantl ‘slice’ while a Tenant 2 may function within a tenant2 slice (and, in further examples, additional or sub-tenants may exist; and each tenant may even be specifically entitled and transactionally tied to a specific set of features all the way down to specific hardware features). A trusted multi-tenant device may further contain a tenant specific cryptographic key such that the combination of key and slice may be considered a “root of trust” (RoT) or tenant specific RoT. A RoT may further be computed or dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 722, 724 may operate as loadable security module (LSM) or security feature enforcement points for local resources allocated to multiple tenants per node. Additionally, tenant runtime and application execution (e.g., in instances 732, 734) may serve as an enforcement point for an LSM or other security feature that creates a virtual edge abstraction of resources spanning potentially multiple physical hosting platforms. Finally, the orchestration functions 760 at an orchestration entity may operate as an LSM or security feature enforcement point for marshalling resources along tenant boundaries.

Edge computing nodes may partition resources (memory, CPU, GPU, interrupt controller, I/O controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 710, 722, and 740 may coordinate the establishment of a distributed trusted computing base (DTCB) such that a tenant-specific virtual trusted secure channel linking all elements end to end can be established.

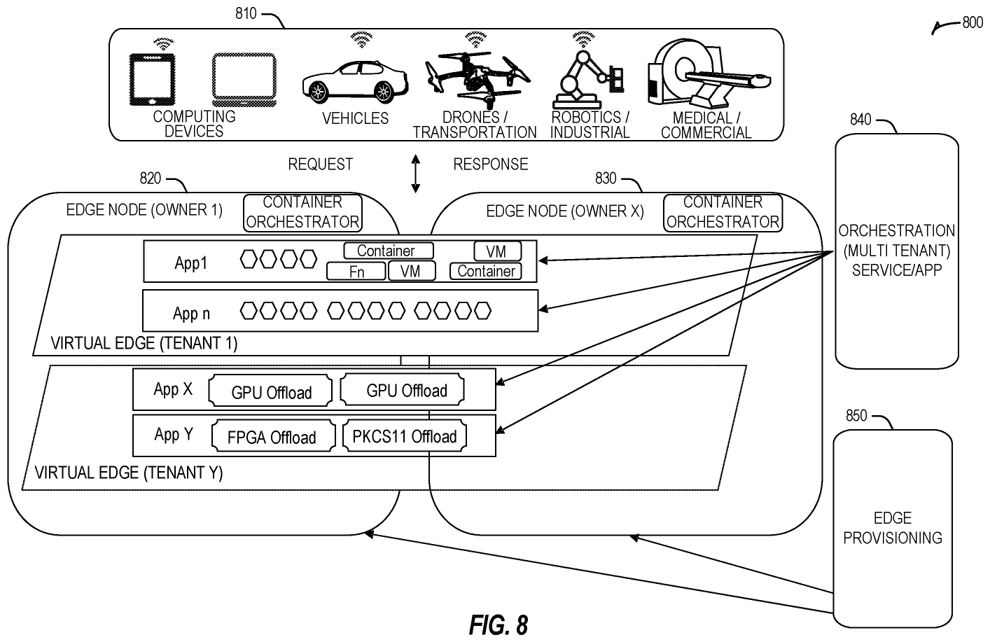

In the example of FIG. 8, an edge computing system 800 is extended to provide for orchestration of multiple applications through the use of containers (e.g., a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 7. An orchestrator may use a DICE layering and fan-out construction to create a root of trust context that is tenant specific. Thus, orchestration functions 840, provided by an orchestrator discussed below, may participate as a tenant-specific orchestration provider.

Similar to the scenario of FIG. 7, the edge computing system 800 is configured to fulfill requests and responses for various client endpoints 810 from multiple virtual edge instances (and, from a cloud or remote data center, not shown). The use of these virtual edge instances supports multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or respective computing systems and resources which are co-owned or co-managed by multiple owners).

Within the edge cloud, a first edge node 820 (operated by a first owner) and a second edge node 830 (operated by a second owner) respectively operate an orchestrator to coordinate the execution of various applications within the virtual edge instances offered for respective tenants. The edge nodes 820, 830 are coordinated based on edge provisioning functions 850, while the operation of the various applications are coordinated with orchestration functions 840. Furthermore, the orchestrator may identify specific hardware features that are offered to one owner but hidden from a second owner, however offered across the ownership boundaries in order to ensure that services complete according to their SLA(s). Accordingly, the virtual edge, container orchestrator, and service/app orchestrator may provide an LSM or other security enforcement point, for node-specific resources tied to specific tenants.

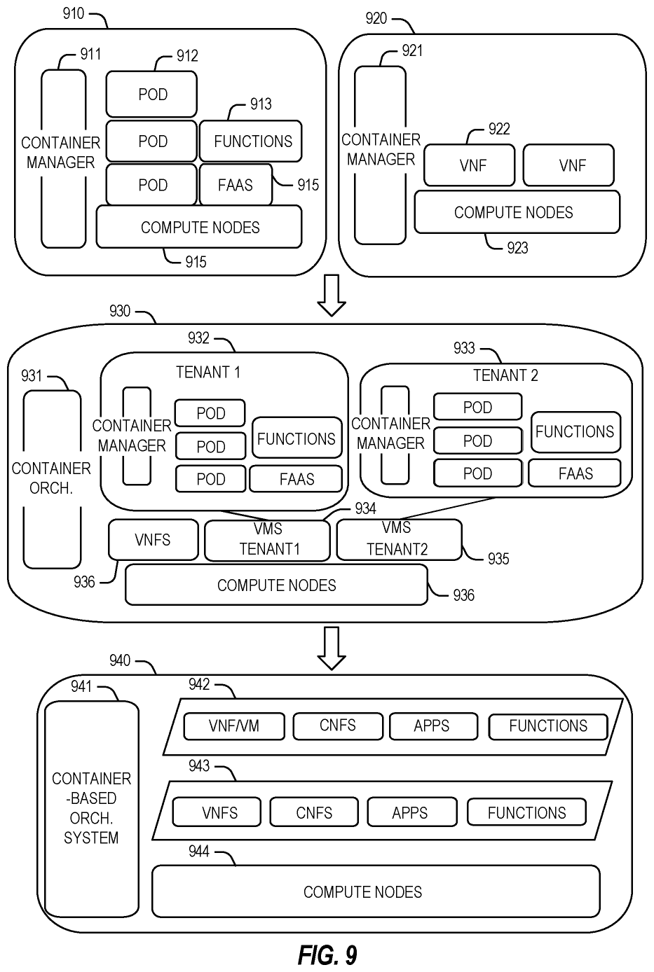

FIG. 9 illustrates various compute arrangements deploying containers in an edge computing system. As a simplified example, system arrangements 910, 920 depict settings in which a container manager (e.g., container managers 911, 921, 931) is adapted to launch containerized pods, functions, and functions-as-a-service instances through execution via compute nodes (915 in arrangement 910), or to separately execute containerized virtualized network functions through execution via compute nodes (923 in arrangement 920). This arrangement is adapted for use of multiple tenants in system arrangement 930 (using compute nodes 936), where containerized pods (e.g., pods 912), functions (e.g., functions 913, VNFs 922, 936), and functions-as-a-service instances (e.g., FaaS instance 915) are launched within virtual machines (e.g., VMs 934, 935 for tenants 932, 933) specific to respective tenants (aside the execution of virtualized network functions). This arrangement is further adapted for use in system arrangement 940, which provides containers 942, 943, or execution of the various functions, applications, and functions on compute nodes 944, as coordinated by a container-based orchestration system 941.

The system arrangements depicted in FIGS. 8-9 provide an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 9, the container manager, container orchestrator, and individual nodes may provide an LSM or other security enforcement point. However in either of the configurations of FIGS. 8-9, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by Edge owners to enforce tenancy. Other isolation environments may include: bare metal (dedicated) equipment, virtual machines, containers, virtual machines on containers, or combinations thereof. Functions, such as those provided in a FaaS environment, may run in any of these isolation environments to enforce tenant boundaries.

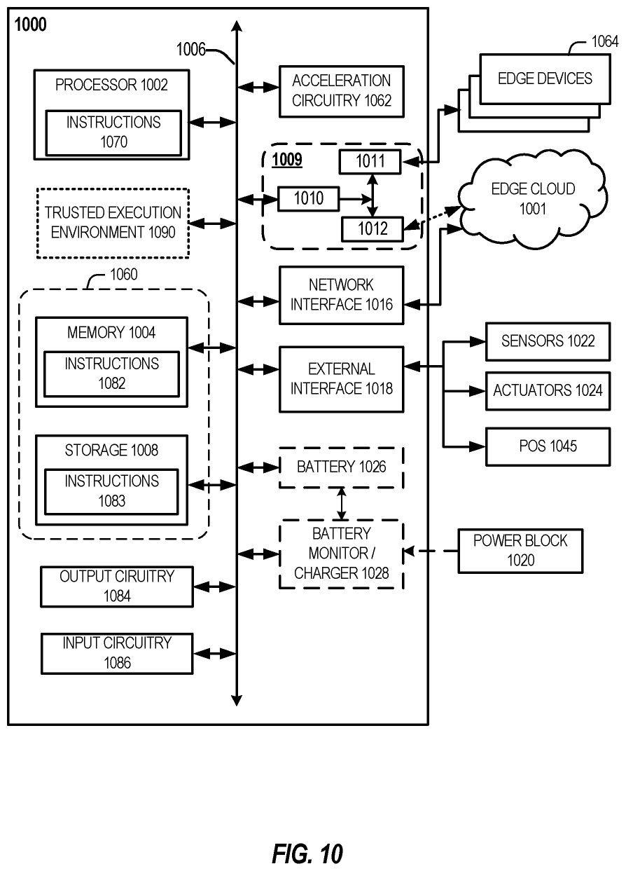

FIG. 10 illustrates an example of a computing platform 1000 (also referred to as “system 1000,” “device 1000,” “appliance 1000,” or the like) in accordance with various embodiments. Platform 1000 may also be implemented in or as a server computer system or some other element, device, or system discussed herein. The platform 1000 may include any combinations of the components shown in the example. The components of platform 1000 may be implemented as integrated circuits (ICs), portions thereof, discrete electronic devices, or other modules, logic, hardware, software, firmware, ora combination thereof adapted in the computer platform 1000, or as components otherwise incorporated within a chassis of a larger system. The example of FIG. 10 is intended to show a high level view of components of the computer platform 1000. However, some of the components shown may be omitted, additional components may be present, and different arrangement of the components shown may occur in other implementations.

The platform 1000 includes processor circuitry 1002. The processor circuitry 1002 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1002 may include one or more hardware accelerators 1062, which may be microprocessors, programmable processing devices (e.g., FPGA, ASIC, etc.), or the like. The one or more hardware accelerators 1062 may include, for example, computer vision and/or deep learning accelerators. In some implementations, the processor circuitry 1002 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of processor circuitry 1002 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, or any suitable combination thereof. The processors (or cores) of the processor circuitry 1002 may be coupled with or may include memory/storage and may be configured to execute instructions stored in the memory/storage to enable various applications or operating systems to run on the platform 1000. In these embodiments, the processors (or cores) of the processor circuitry 1002 is configured to operate application software to provide a specific service to a user of the platform 1000. In some embodiments, the processor circuitry 1002 may be a special-purpose processor/controller to operate according to the various embodiments herein.

As examples, the processor circuitry 1002 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, Calif. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centrig™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor circuitry 1002 may be a part of a system on a chip (SoC), System-in-Package (SiP), a multi-chip package (MCP), and/or the like, in which the processor circuitry 1002 and other components are formed into a single integrated circuit, or a single package, such as the Edison™ or Galileo™ SoC boards from Intel® Corporation. Other examples of the processor circuitry 1002 are mentioned elsewhere in the present disclosure.

Additionally or alternatively, processor circuitry 1002 may include circuitry such as, but not limited to, one or more FPDs such as FPGAs and the like; PLDs such as CPLDs, HCPLDs, and the like; ASICs such as structured ASICs and the like; PSoCs; and the like. In such embodiments, the circuitry of processor circuitry 1002 may comprise logic blocks or logic fabric including and other interconnected resources that may be programmed to perform various functions, such as the procedures, methods, functions, etc. of the various embodiments discussed herein. In such embodiments, the circuitry of processor circuitry 1002 may include memory cells (e.g., EPROM, EEPROM, flash memory, static memory (e.g., SRAM, anti-fuses, etc.) used to store logic blocks, logic fabric, data, etc. in LUTs and the like.

The processor circuitry 1002 may communicate with system memory circuitry 1004 over an interconnect 1006 (e.g., a bus). Any number of memory devices may be used to provide for a given amount of system memory. As examples, the memory circuitry 1004 may be random access memory (RAM) in accordance with a Joint Electron Devices Engineering Council (JEDEC) design such as the DDR or mobile DDR standards (e.g., LPDDR, LPDDR2, LPDDR3, or LPDDR4), dynamic RAM (DRAM), and/or synchronous DRAM (SDRAM)). The memory circuitry 1004 may also include nonvolatile memory (NVM) such as high-speed electrically erasable memory (commonly referred to as “flash memory”), phase change RAM (PRAM), resistive memory such as magnetoresistive random access memory (MRAM), etc., and may incorporate three-dimensional (3D) cross-point (XPOINT) memories from Intel® and Micron®. The memory circuitry 1004 may also comprise persistent storage devices, which may be temporal and/or persistent storage of any type, including, but not limited to, non-volatile memory, optical, magnetic, and/or solid state mass storage, and so forth.

The individual memory devices of memory circuitry 1004 may be implemented as one or more of solder down packaged integrated circuits, socketed memory modules, and plug-in memory cards. The memory circuitry 1004 may be implemented as any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs. In embodiments, the memory circuitry 1004 may be disposed in or on a same die or package as the processor circuitry 1002 (e.g., a same SoC, a same SiP, or soldered on a same MCP as the processor circuitry 1002).

To provide for persistent storage of information such as data, applications, operating systems (OS), and so forth, a storage circuitry 1008 may also couple to the processor circuitry 1002 via the interconnect 1006. In an example, the storage circuitry 1008 may be implemented via a solid-state disk drive (SSDD). Other devices that may be used for the storage circuitry 1008 include flash memory cards, such as SD cards, microSD cards, xD picture cards, and the like, and USB flash drives. In low power implementations, the storage circuitry 1008 may be on-die memory or registers associated with the processor circuitry 1002. However, in some examples, the storage circuitry 1008 may be implemented using a micro hard disk drive (HDD). Further, any number of new technologies may be used for the storage circuitry 1008 in addition to, or instead of, the technologies described, such resistance change memories, phase change memories, holographic memories, or chemical memories, among others.

The storage circuitry 1008 store computational logic 1083 (or “modules 1083”) in the form of software, firmware, or hardware commands to implement the techniques described herein. The computational logic 1083 may be employed to store working copies and/or permanent copies of computer programs, or data to create the computer programs, for the operation of various components of platform 1000 (e.g., drivers, etc.), an OS of platform 1000 and/or one or more applications for carrying out the embodiments discussed herein. The computational logic 1083 may be stored or loaded into memory circuitry 1004 as instructions 1082, or data to create the instructions 1082, for execution by the processor circuitry 1002 to provide the functions described herein. The various elements may be implemented by assembler instructions supported by processor circuitry 1002 or high-level languages that may be compiled into such instructions (e.g., instructions 1070, or data to create the instructions 1070). The permanent copy of the programming instructions may be placed into persistent storage devices of storage circuitry 1008 in the factory or in the field through, for example, a distribution medium (not shown), through a communication interface (e.g., from a distribution server (not shown)), or over-the-air (OTA).

In an example, the instructions 1082 provided via the memory circuitry 1004 and/or the storage circuitry 1008 of FIG. 10 are embodied as one or more non-transitory computer readable storage media (see e.g., NTCRSM 1060) including program code, a computer program product or data to create the computer program, with the computer program or data, to direct the processor circuitry 1002 of platform 1000 to perform electronic operations in the platform 1000, and/or to perform a specific sequence or flow of actions, for example, as described with respect to the flowchart(s) and block diagram(s) of operations and functionality depicted previously. The processor circuitry 1002 accesses the one or more non-transitory computer readable storage media over the interconnect 1006.

In alternate embodiments, programming instructions (or data to create the instructions) may be disposed on multiple NTCRSM 1060. In alternate embodiments, programming instructions (or data to create the instructions) may be disposed on computer-readable transitory storage media, such as, signals. The instructions embodied by a machine-readable medium may further be transmitted or received over a communications network using a transmission medium via a network interface device utilizing any one of a number of transfer protocols (e.g., HTTP). Any combination of one or more computer usable or computer readable medium(s) may be utilized. The computer-usable or computer-readable medium may be, for example but not limited to, one or more electronic, magnetic, optical, electromagnetic, infrared, or semiconductor systems, apparatuses, devices, or propagation media. For instance, the NTCRSM 1060 may be embodied by devices described for the storage circuitry 1008 and/or memory circuitry 1004. More specific examples (a non-exhaustive list) of a computer-readable medium would include the following: an electrical connection having one or more wires, a portable computer diskette, a hard disk, a random access memory (RAM), a read-only memory (ROM), an erasable programmable read-only memory (EPROM, Flash memory, etc.), an optical fiber, a portable compact disc read-only memory (CD-ROM), an optical storage device and/or optical disks, a transmission media such as those supporting the Internet or an intranet, a magnetic storage device, or any number of other hardware devices. Note that the computer-usable or computer-readable medium could even be paper or another suitable medium upon which the program (or data to create the program) is printed, as the program (or data to create the program) can be electronically captured, via, for instance, optical scanning of the paper or other medium, then compiled, interpreted, or otherwise processed in a suitable manner, if necessary, and then stored in a computer memory (with or without having been staged in or more intermediate storage media). In the context of this document, a computer-usable or computer-readable medium may be any medium that can contain, store, communicate, propagate, or transport the program (or data to create the program) for use by or in connection with the instruction execution system, apparatus, or device. The computer-usable medium may include a propagated data signal with the computer-usable program code (or data to create the program code) embodied therewith, either in baseband or as part of a carrier wave. The computer usable program code (or data to create the program) may be transmitted using any appropriate medium, including but not limited to wireless, wireline, optical fiber cable, RF, etc.

In various embodiments, the program code (or data to create the program code) described herein may be stored in one or more of a compressed format, an encrypted format, a fragmented format, a packaged format, etc. Program code (or data to create the program code) as described herein may require one or more of installation, modification, adaptation, updating, combining, supplementing, configuring, decryption, decompression, unpacking, distribution, reassignment, etc. in order to make them directly readable and/or executable by a computing device and/or other machine. For example, the program code (or data to create the program code) may be stored in multiple parts, which are individually compressed, encrypted, and stored on separate computing devices, wherein the parts when decrypted, decompressed, and combined form a set of executable instructions that implement the program code (the data to create the program code such as that described herein. In another example, the Program code (or data to create the program code) may be stored in a state in which they may be read by a computer, but require addition of a library (e.g., a dynamic link library), a software development kit (SDK), an application programming interface (API), etc. in order to execute the instructions on a particular computing device or other device. In another example, the program code (or data to create the program code) may need to be configured (e.g., settings stored, data input, network addresses recorded, etc.) before the program code (or data to create the program code) can be executed/used in whole or in part. In this example, the program code (or data to create the program code) may be unpacked, configured for proper execution, and stored in a first location with the configuration instructions located in a second location distinct from the first location. The configuration instructions can be initiated by an action, trigger, or instruction that is not collocated in storage or execution location with the instructions enabling the disclosed techniques. Accordingly, the disclosed program code (or data to create the program code) are intended to encompass such machine readable instructions and/or program(s) (or data to create such machine readable instruction and/or programs) regardless of the particular format or state of the machine readable instructions and/or program(s) when stored or otherwise at rest or in transit.

Computer program code for carrying out operations of the present disclosure (e.g., computational logic 1083, instructions 1082, 1070 discussed previously) may be written in any combination of one or more programming languages, including an object oriented programming language such as Python, Ruby, Scala, Smalltalk, Java™, C++, C#, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML), Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code for carrying out operations of the present disclosure may also be written in any combination of the programming languages discussed herein. The program code may execute entirely on the system 1000, partly on the system 1000, as a stand-alone software package, partly on the system 1000 and partly on a remote computer or entirely on the remote computer or server. In the latter scenario, the remote computer may be connected to the system 1000 through any type of network, including a LAN or WAN, or the connection may be made to an external computer (e.g., through the Internet using an Internet Service Provider).

In an example, the instructions 1070 on the processor circuitry 1002 (separately, or in combination with the instructions 1082 and/or logic/modules 1083 stored in computer-readable storage media) may configure execution or operation of a trusted execution environment (TEE) 1090. The TEE 1090 operates as a protected area accessible to the processor circuitry 1002 to enable secure access to data and secure execution of instructions. In some embodiments, the TEE 1090 may be a physical hardware device that is separate from other components of the system 1000 such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC), Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability, Apple® Secure Enclave coprocessor; IBM® Crypto Express3®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated DellTM Remote Assistant Card (iDRAC), and the like.

In other embodiments, the TEE 1090 may be implemented as secure enclaves, which are isolated regions of code and/or data within the processor and/or memory/storage circuitry of the system 1000. Only code executed within a secure enclave may access data within the same secure enclave, and the secure enclave may only be accessible using the secure application (which may be implemented by an application processor or a tamper-resistant microcontroller). Various implementations of the TEE 1090, and an accompanying secure area in the processor circuitry 1002 or the memory circuitry 1004 and/or storage circuitry 1008 may be provided, for instance, through use of Intel° Software Guard Extensions (SGX), ARM® TrustZone® hardware security extensions, Keystone Enclaves provided by Oasis Labs™, and/or the like. Other aspects of security hardening, hardware roots-of-trust, and trusted or protected operations may be implemented in the device 1000 through the TEE 1090 and the processor circuitry 1002.

In some embodiments, the memory circuitry 1004 and/or storage circuitry 1008 may be divided into isolated user-space instances such as containers, partitions, virtual environments (VEs), etc. The isolated user-space instances may be implemented using a suitable OS-level virtualization technology such as Docker® containers, Kubernetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 1004 and/or storage circuitry 1008 may be divided into one or more trusted memory regions for storing applications or software modules of the TEE 1090.

Although the instructions 1082 are shown as code blocks included in the memory circuitry 1004 and the computational logic 1083 is shown as code blocks in the storage circuitry 1008, it should be understood that any of the code blocks may be replaced with hardwired circuits, for example, built into an FPGA, ASIC, or some other suitable circuitry. For example, where processor circuitry 1002 includes (e.g., FPGA based) hardware accelerators as well as processor cores, the hardware accelerators (e.g., the FPGA cells) may be pre-configured (e.g., with appropriate bit streams) with the aforementioned computational logic to perform some or all of the functions discussed previously (in lieu of employment of programming instructions to be executed by the processor core(s)).

The memory circuitry 1004 and/or storage circuitry 1008 may store program code of an operating system (OS), which may be a general purpose OS or an OS specifically written for and tailored to the computing platform 1000. For example, the OS may be Unix or a Unix-like OS such as Linux e.g., provided by Red Hat Enterprise, Windows IOT™ provided by Microsoft Corp.®, macOS provided by Apple Inc.®, or the like. In another example, the OS may be a mobile OS, such as Android® provided by Google Inc.®, iOS® provided by Apple Inc.®, Windows 10 Mobile® provided by Microsoft Corp.®, KaiOS provided by KaiOS Technologies Inc., or the like. In another example, the OS may be a real-time OS (RTOS), such as Apache Mynewt provided by the Apache Software Foundation®, Windows 10 For IoT® provided by Microsoft Corp.®, Micro-Controller Operating Systems (“MicroC/OS” or “μC/OS”) provided by Micrium®, Inc., FreeRTOS, VxWorks® provided by Wind River Systems, Inc.®, PikeOS provided by Sysgo AG®, Android Things® provided by Google Inc.®, QNX® RTOS provided by BlackBerry Ltd., or any other suitable RTOS, such as those discussed herein.

The OS may include one or more drivers that operate to control particular devices that are embedded in the platform 1000, attached to the platform 1000, or otherwise communicatively coupled with the platform 1000. The drivers may include individual drivers allowing other components of the platform 1000 to interact or control various I/O devices that may be present within, or connected to, the platform 1000. For example, the drivers may include a display driver to control and allow access to a display device, a touchscreen driver to control and allow access to a touchscreen interface of the platform 1000, sensor drivers to obtain sensor readings of sensor circuitry 1021 and control and allow access to sensor circuitry 1021, actuator drivers to obtain actuator positions of the actuators 1022 and/or control and allow access to the actuators 1022, a camera driver to control and allow access to an embedded image capture device, audio drivers to control and allow access to one or more audio devices. The OSs may also include one or more libraries, drivers, APIs, firmware, middleware, software glue, etc., which provide program code and/or software components for one or more applications to obtain and use the data from a secure execution environment, trusted execution environment, and/or management engine of the platform 1000 (not shown).

The components may communicate over the IX 1006. The IX 1006 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, and/or any number of other IX technologies. The IX 1006 may be a proprietary bus, for example, used in a SoC based system.

The interconnect 1006 couples the processor circuitry 1002 to the communication circuitry 1009 for communications with other devices. The communication circuitry 1009 is a hardware element, or collection of hardware elements, used to communicate over one or more networks (e.g., cloud 1001) and/or with other devices (e.g., mesh devices/fog 1064). The communication circuitry 1009 includes baseband circuitry 1010 (or “modem 1010”) and RF circuitry 1011 and 1012.

The baseband circuitry 1010 includes one or more processing devices (e.g., baseband processors) to carry out various protocol and radio control functions. Baseband circuitry 1010 may interface with application circuitry of platform 1000 (e.g., a combination of processor circuitry 1002, memory circuitry 1004, and/or storage circuitry 1008) for generation and processing of baseband signals and for controlling operations of the RF circuitry 1011 or 1012. The baseband circuitry 1010 may handle various radio control functions that enable communication with one or more radio networks via the RF circuitry 1011 or 1012. The baseband circuitry 1010 may include circuitry such as, but not limited to, one or more single-core or multi-core processors (e.g., one or more baseband processors) or control logic to process baseband signals received from a receive signal path of the RF circuitry 1011 and/or 1012, and to generate baseband signals to be provided to the RF circuitry 1011 or 1012 via a transmit signal path. In various embodiments, the baseband circuitry 1010 may implement an RTOS to manage resources of the baseband circuitry 1010, schedule tasks, etc. Examples of the RTOS may include Operating System Embedded (OSE)TM provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein.

Although not shown by FIG. 10, in one embodiment, the baseband circuitry 1010 includes individual processing device(s) to operate one or more wireless communication protocols (e.g., a “multi-protocol baseband processor” or “protocol processing circuitry”) and individual processing device(s) to implement PHY functions. In this embodiment, the protocol processing circuitry operates or implements various protocol layers/entities of one or more wireless communication protocols. In a first example, the protocol processing circuitry may operate LTE protocol entities and/or 5G)/NR protocol entities when the communication circuitry 1009 is a cellular radiofrequency communication system, such as millimeter wave (mmWave) communication circuitry or some other suitable cellular communication circuitry. In the first example, the protocol processing circuitry 1002 would operate MAC, RLC, PDCP, SDAP, RRC, and NAS functions. In a second example, the protocol processing circuitry may operate one or more IEEE-based protocols when the communication circuitry 1009 is WiFi communication system. In the second example, the protocol processing circuitry would operate WiFi MAC and LLC functions. The protocol processing circuitry may include one or more memory structures (not shown) to store program code and data for operating the protocol functions, as well as one or more processing cores (not shown) to execute the program code and perform various operations using the data. The protocol processing circuitry provides control functions for the baseband circuitry 1010 and/or RF circuitry 1011 and 1012. The baseband circuitry 1010 may also support radio communications for more than one wireless protocol.

Continuing with the aforementioned embodiment, the baseband circuitry 1010 includes individual processing device(s) to implement PHY including HARQ functions, scrambling and/or descrambling, (en)coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, radio frequency shifting, and other related functions. etc. The modulation/demodulation functionality may include Fast-Fourier Transform (FFT), precoding, or constellation mapping/demapping functionality. The (en)coding/decoding functionality may include convolution, tail-biting convolution, turbo, Viterbi, or Low Density Parity Check (LDPC) coding. Embodiments of modulation/demodulation and encoder/decoder functionality are not limited to these examples and may include other suitable functionality in other embodiments.

The communication circuitry 1009 also includes RF circuitry 1011 and 1012 to enable communication with wireless networks using modulated electromagnetic radiation through a non-solid medium. Each of the RF circuitry 1011 and 1012 include a receive signal path, which may include circuitry to convert analog RF signals (e.g., an existing or received modulated waveform) into digital baseband signals to be provided to the baseband circuitry 1010. Each of the RF circuitry 1011 and 1012 also include a transmit signal path, which may include circuitry configured to convert digital baseband signals provided by the baseband circuitry 1010 to be converted into analog RF signals (e.g., modulated waveform) that will be amplified and transmitted via an antenna array including one or more antenna elements (not shown). The antenna array may be a plurality of microstrip antennas or printed antennas that are fabricated on the surface of one or more printed circuit boards. The antenna array may be formed in as a patch of metal foil (e.g., a patch antenna) in a variety of shapes, and may be coupled with the RF circuitry 1011 or 1012 using metal transmission lines or the like.

The RF circuitry 1011 (also referred to as a “mesh transceiver”) is used for communications with other mesh or fog devices 1064. The mesh transceiver 1011 may use any number of frequencies and protocols, such as 2.4 GHz transmissions under the IEEE 802.15.4 standard, using the Bluetooth® low energy (BLE) standard, as defined by the Bluetooth® Special Interest Group, or the ZigBee® standard, among others. Any number of RF circuitry 1011, configured for a particular wireless communication protocol, may be used for the connections to the mesh devices 1064. For example, a WLAN unit may be used to implement WiFi™ communications in accordance with the IEEE 802.11 standard. In addition, wireless wide area communications, for example, according to a cellular or other wireless wide area protocol, may occur via a WWAN unit.

The mesh transceiver 1011 may communicate using multiple standards or radios for communications at different ranges. For example, the platform 1000 may communicate with close/proximate devices, e.g., within about 10 meters, using a local transceiver based on BLE, or another low power radio, to save power. More distant mesh devices 1064, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

The RF circuitry 1012 (also referred to as a “wireless network transceiver,” a “cloud transceiver,” or the like) may be included to communicate with devices or services in the cloud 1001 via local or wide area network protocols. The wireless network transceiver 1012 includes one or more radios to communicate with devices in the cloud 1001. The cloud 1001 may be the same or similar to cloud 144 discussed previously. The wireless network transceiver 1012 may be a LPWA transceiver that follows the IEEE 802.15.4, or IEEE 802.15.4g standards, among others, such as those discussed herein. The platform 1000 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 1002.15.4e specification may be used.

Any number of other radio communications and protocols may be used in addition to the systems mentioned for the mesh transceiver 1011 and wireless network transceiver 1012, as described herein. For example, the radio transceivers 1011 and 1012 may include an LTE or other cellular transceiver that uses spread spectrum (SPA/SAS) communications for implementing high-speed communications. Further, any number of other protocols may be used, such as WiFi® networks for medium speed communications and provision of network communications.

The transceivers 1011 and 1012 may include radios that are compatible with, and/or may operate according to any one or more of the following radio communication technologies and/or standards including but not limited to those discussed herein.

Network interface circuitry/controller (NIC) 1016 may be included to provide wired communication to the cloud 1001 or to other devices, such as the mesh devices 1064 using a standard network interface protocol. The standard network interface protocol may include Ethernet, Ethernet over GRE Tunnels, Ethernet over Multiprotocol Label Switching (MPLS), Ethernet over USB, or may be based on other types of network protocols, such as Controller Area Network (CAN), Local Interconnect Network (LIN), DeviceNet, ControlNet, Data Highway+, PROFIBUS, or PROFINET, among many others. Network connectivity may be provided to/from the platform 1000 via NIC 1016 using a physical or wired connection, such as electrical (e.g., a “copper interconnect”), optical (e.g., fiber optics, and/or any other type of conductive or transmissive physical communication medium. The physical connection also includes suitable input connectors (e.g., ports, receptacles, sockets, etc.) and output connectors (e.g., plugs, pins, etc.). The NIC 1016 may include one or more dedicated processors and/or FPGAs to communicate using one or more of the aforementioned network interface protocols. In some implementations, the NIC 1016 may include multiple controllers to provide connectivity to other networks using the same or different protocols. For example, the platform 1000 may include a first NIC 1016 providing communications to the cloud over Ethernet and a second NIC 1016 providing communications to other devices over another type of network.

The interconnect 1006 may couple the processor circuitry 1002 to an external interface 1018 (also referred to as “I/O interface circuitry” or the like) that is used to connect external devices or subsystems. The external devices include, inter alia, sensor circuitry 1021, actuators 1022, and positioning circuitry 1045.

The sensor circuitry 1021 may include devices, modules, or subsystems whose purpose is to detect events or changes in its environment and send the information (sensor data) about the detected events to some other a device, module, subsystem, etc. Examples of such sensors 1021 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The external interface 1018 connects the platform 1000 to actuators 1022, allow platform 1000 to change its state, position, and/or orientation, or move or control a mechanism or system. The actuators 1022 comprise electrical and/or mechanical devices for moving or controlling a mechanism or system, and converts energy (e.g., electric current or moving air and/or liquid) into some kind of motion. The actuators 1022 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 1022 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The platform 1000 may be configured to operate one or more actuators 1022 based on one or more captured events and/or instructions or control signals received from a service provider and/or various client systems.

The positioning circuitry 1045 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 1045 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 1045 may include a Micro-Technology for Positioning, Navigation, and Timing (Micro-PNT) IC that uses a master timing clock to perform position tracking/estimation without GNSS assistance. The positioning circuitry 1045 may also be part of, or interact with, the communication circuitry 1009 to communicate with the nodes and components of the positioning network. The positioning circuitry 1045 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS).

In some implementations, the positioning circuitry 1045 is, or includes an INS, which is a system or device that uses sensor circuitry 1021 (e.g., motion sensors such as accelerometers, rotation sensors such as gyroscopes, and altimimeters, magnetic sensors, and/or the like to continuously calculate (e.g., using dead by dead reckoning, tria-Angulation, or the like) a position, orientation, and/or velocity (including direction and speed of movement) of the platform 1000 without the need for external references.

In some examples, various I/O devices may be present within, or connected to, the platform 1000, which are referred to as input device circuitry 1086 and output device circuitry 1084 in FIG. 10. The input device circuitry 1086 and output device circuitry 1084 include one or more user interfaces designed to enable user interaction with the platform 1000 and/or peripheral component interfaces designed to enable peripheral component interaction with the platform 1000. Input device circuitry 1086 may include any physical or virtual means for accepting an input including, inter alia, one or more physical or virtual buttons (e.g., a reset button), a physical keyboard, keypad, mouse, touchpad, touchscreen, microphones, scanner, headset, and/or the like.

The output device circuitry 1084 may be included to show information or otherwise convey information, such as sensor readings, actuator position(s), or other like information. Data and/or graphics may be displayed on one or more user interface components of the output device circuitry 1084. Output device circuitry 1084 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 1000. The output device circuitry 1084 may also include speakers or other audio emitting devices, printer(s), and/or the like. In some embodiments, the sensor circuitry 1021 may be used as the input device circuitry 1086 (e.g., an image capture device, motion capture device, or the like) and one or more actuators 1022 may be used as the output device circuitry 1084 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

A battery 1024 may be coupled to the platform 1000 to power the platform 1000, which may be used in embodiments where the platform 1000 is not in a fixed location. The battery 1024 may be a lithium ion battery, a lead-acid automotive battery, or a metal-air battery, such as a zinc-air battery, an aluminum-air battery, a lithium-air battery, a lithium polymer battery, and/or the like. In embodiments where the platform 1000 is mounted in a fixed location, the platform 1000 may have a power supply coupled to an electrical grid. In these embodiments, the platform 1000 may include power tee circuitry to provide for electrical power drawn from a network cable to provide both power supply and data connectivity to the platform 1000 using a single cable.

PMIC 1026 may be included in the platform 1000 to track the state of charge (SoCh) of the battery 1024, and to control charging of the platform 1000. The PMIC 1026 may be used to monitor other parameters of the battery 1024 to provide failure predictions, such as the state of health (SoH) and the state of function (SoF) of the battery 1024. The PMIC 1026 may include voltage regulators, surge protectors, power alarm detection circuitry. The power alarm detection circuitry may detect one or more of brown out (under-voltage) and surge (over-voltage) conditions. The PMIC 1026 may communicate the information on the battery 1024 to the processor circuitry 1002 over the interconnect 1006. The PMIC 1026 may also include an analog-to-digital (ADC) convertor that allows the processor circuitry 1002 to directly monitor the voltage of the battery 1024 or the current flow from the battery 1024. The battery parameters may be used to determine actions that the platform 1000 may perform, such as transmission frequency, mesh network operation, sensing frequency, and the like. As an example, the PMIC 1026 may be a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, Tex.

A power block 1028, or other power supply coupled to a grid, may be coupled with the PMIC 1026 to charge the battery 1024. In some examples, the power block 1028 may be replaced with a wireless power receiver to obtain the power wirelessly, for example, through a loop antenna in the platform 1000. A wireless battery charging circuit, such as an LTC4020 chip from Linear Technologies of Milpitas, Calif., among others, may be included in the PMIC 1026. The specific charging circuits chosen depend on the size of the battery 1024, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a system comprising a cluster manager comprising processing circuitry to request, from an image registry, at least one virtual environment image block of a virtual environment image defining a virtual environment; and process the at least one virtual environment image block upon reception of the at least one virtual environment image block from the image registry; and communication circuitry to communicate the processed at least one virtual environment image block to a worker node that is to execute the virtual environment.

Example 2 includes the subject matter of Example 1, and wherein the communication circuitry is to communicate the processed at least one virtual environment image block to a second worker node that is to execute the virtual environment.

Example 3 includes the subject matter of any of Examples 1 and 2, and wherein the processing circuitry is to request the at least one virtual environment image block from the image registry based on a list of images to be prefetched, wherein the list is received from an orchestration manager.

Example 4 includes the subject matter of any of Examples 1-3, and wherein the processing circuitry is to request the at least one virtual environment image block from the image registry based on a request for a microservice from the worker node, wherein the microservice is associated with the at least one virtual environment image block.

Example 5 includes the subject matter of any of Examples 1-4, and wherein the communication circuitry is to communicate an identification of the requested at least one virtual environment image block to a second cluster manager to prompt the second cluster manager to prefetch the at least one virtual environment image block from the image registry.

Example 6 includes the subject matter of any of Examples 1-5, and wherein the communication circuitry is to communicate the processed at least one virtual environment image block to a second cluster manager for provision to a second worker node that is to execute the virtual environment.

Example 7 includes the subject matter of any of Examples 1-6, and wherein the communication circuitry is to encrypt the processed at least one virtual environment image block according to a communication protocol prior to communicating the processed at least one virtual environment image block to the worker node.

Example 8 includes the subject matter of any of Examples 1-7, and wherein the communication protocol is a CXL protocol.

Example 9 includes the subject matter of any of Examples 1-8, and wherein processing the at least one virtual environment image block comprises decrypting the at least one virtual environment image block.

Example 10 includes the subject matter of any of Examples 1-9, and wherein processing the at least one virtual environment image block comprises decompressing the at least one virtual environment image block.

Example 11 includes the subject matter of any of Examples 1-10, and wherein processing the at least one virtual environment image block comprises performing cyclic redundancy check operations on the at least one virtual environment image block.

Example 12 includes the subject matter of any of Examples 1-11, and further including at least one computing system to calculate a score for the virtual environment and a plurality of prospective scores for the virtual environment at prospective locations; and to initiate movement of the virtual environment from the worker node to a different worker node based on a prospective score that is higher than the score.

Example 13 includes the subject matter of any of Examples 1-12, and wherein the score is based on characteristics of network traffic between the virtual environment and a plurality of other virtual environments as well as distance metrics between a current location of the virtual environment and locations of the plurality of other virtual environments.

Example 14 includes the subject matter of any of Examples 1-13, and wherein the plurality of prospective scores are based on the characteristics of network traffic between the virtual environment and the plurality of other virtual environments as well as distance metrics between the prospective locations for the virtual environment and the locations of the plurality of other virtual environments.

Example 15 includes at least one non-transitory machine-readable storage medium having instructions stored thereon, wherein the instructions, when executed on a machine, cause the machine to send a request to an image registry for at least one virtual environment image block of an image for a virtual environment; process the at least one virtual environment image block upon reception of the at least one virtual environment image block from the image registry; and communicate the processed at least one virtual environment image block to a worker node that is to execute the virtual environment.

Example 16 includes the subject matter of Example 15, and wherein the instructions, when executed on the machine, are to cause the machine to communicate the processed at least one virtual environment image block to a second worker node that is to execute the virtual environment.

Example 17 includes the subject matter of any of Examples 15-16, and wherein the request to the image registry is sent based on a list of images to be prefetched, wherein the list is generated by an orchestration manager.

Example 18 includes the subject matter of any of Examples 15-17, and wherein the request to the image registry is sent based on a request from the worker node for the at least one virtual environment image block.

Example 19 includes the subject matter of any of Examples 15-18, and wherein the instructions, when executed on the machine, are to cause the machine to communicate an identification of the requested at least one virtual environment image block to a second cluster manager to prompt the second cluster manager to prefetch the at least one virtual environment image block from the image registry.

Example 20 includes the subject matter of any of Examples 15-19, and wherein the instructions, when executed on the machine, are to cause the machine to communicate the processed at least one virtual environment image block to a second cluster manager for provision to a second worker node that is to execute the virtual environment.

Example 21 includes the subject matter of any of Examples 15-20, and wherein the instructions, when executed on the machine, are to cause the machine to encrypt the processed at least one virtual environment image block according to a communication protocol prior to communicating the processed at least one virtual environment image block to the worker node.

Example 22 includes the subject matter of any of Examples 15-21, and wherein the communication protocol is a CXL protocol.

Example 23 includes the subject matter of any of Examples 15-22, and wherein processing the at least one virtual environment image block comprises decrypting the at least one virtual environment image block.

Example 24 includes the subject matter of any of Examples 15-23, and wherein processing the at least one virtual environment image block comprises decompressing the at least one virtual environment image block.

Example 25 includes the subject matter of any of Examples 15-24, and wherein processing the at least one virtual environment image block comprises performing cyclic redundancy check operations on the at least one virtual environment image block.

Example 26 includes the subject matter of any of Examples 15-25, and wherein the instructions, when executed on the machine, are to cause the machine to calculate a score for the virtual environment and a plurality of prospective scores for the virtual environment at prospective locations; and to initiate movement of the virtual environment from the worker node to a different worker node based on a prospective score that is higher than the score.

Example 27 includes the subject matter of any of Examples 15-26, and wherein the score is based on characteristics of network traffic between the virtual environment and a plurality of other virtual environments as well as distance metrics between a current location of the virtual environment and locations of the plurality of other virtual environments.

Example 28 includes the subject matter of any of Examples 15-27, wherein the plurality of prospective scores are based on the characteristics of network traffic between the virtual environment and the plurality of other virtual environments as well as distance metrics between the prospective locations for the virtual environment and the locations of the plurality of other virtual environments.

Example 29 includes a method comprising sending a request to an image registry for at least one virtual environment image block of an image for a virtual environment; processing the at least one virtual environment image block upon reception of the at least one virtual environment image block from the image registry; and communicating the processed at least one virtual environment image block to a worker node that is to execute the virtual environment.

Example 30 includes the subject matter of Example 29, and further including communicating the processed at least one virtual environment image block to a second worker node that is to execute the virtual environment.

Example 31 includes the subject matter of any of Examples 29 and 30, and further including requesting the at least one virtual environment image block from the image registry based on a list of images to be prefetched, wherein the list is received from an orchestration manager.

Example 32 includes the subject matter of any of Examples 29-31, and further including requesting the at least one virtual environment image block from the image registry based on a request from the worker node for the at least one virtual environment image block.

Example 33 includes the subject matter of any of Examples 29-32, and further including communicating an identification of the requested at least one virtual environment image block to a second cluster manager to prompt the second cluster manager to prefetch the at least one virtual environment image block from the image registry.

Example 34 includes the subject matter of any of Examples 29-33, and further including communicating the processed at least one virtual environment image block to a second cluster manager for provision to a second worker node that is to execute the virtual environment.

Example 35 includes the subject matter of any of Examples 29-34, and further including encrypting the processed at least one virtual environment image block according to a communication protocol prior to communicating the processed at least one virtual environment image block to the worker node.

Example 36 includes the subject matter of any of Examples 29-35, and wherein the communication protocol is a CXL protocol.

Example 37 includes the subject matter of any of Examples 29-36, and wherein processing the at least one virtual environment image block comprises decrypting the at least one virtual environment image block.

Example 38 includes the subject matter of any of Examples 29-37, and wherein processing the at least one virtual environment image block comprises decompressing the at least one virtual environment image block.

Example 39 includes the subject matter of any of Examples 29-38, and wherein processing the at least one virtual environment image block comprises performing cyclic redundancy check operations on the at least one virtual environment image block.

Example 40 includes the subject matter of any of Examples 29-39, and further including calculating a score for the virtual environment and a plurality of prospective scores for the virtual environment at prospective locations; and initiating movement of the virtual environment from the worker node to a different worker node based on a prospective score that is higher than the score.

Example 41 includes the subject matter of any of Examples 29-40, and wherein the score is based on characteristics of network traffic between the virtual environment and a plurality of other virtual environments as well as distance metrics between a current location of the virtual environment and locations of the plurality of other virtual environments.

Example 42 includes the subject matter of any of Examples 29-41, and wherein the plurality of prospective scores are based on the characteristics of network traffic between the virtual environment and the plurality of other virtual environments as well as distance metrics between the prospective locations for the virtual environment and the locations of the plurality of other virtual environments.

Example 43 includes means to perform any of the operations of Examples 1-41.

What is claimed is:

1. A system comprising:
a cluster manager comprising:
processing circuitry to:
request, from an image registry, at least one virtual environment image block of a virtual environment image defining a virtual environment; and
process the at least one virtual environment image block upon reception of the at least one virtual environment image block from the image registry; and
communication circuitry to communicate the processed at least one virtual environment image block to a worker node that is to execute the virtual environment.

2. The system of claim 1, wherein the communication circuitry is to communicate the processed at least one virtual environment image block to a second worker node that is to execute the virtual environment.

3. The system of claim 1, wherein the processing circuitry is to request the at least one virtual environment image block from the image registry based on a list of images to be prefetched, wherein the list is received from an orchestration manager.

4. The system of claim 1, wherein the processing circuitry is to request the at least one virtual environment image block from the image registry based on a request for a microservice from the worker node, wherein the microservice is associated with the at least one virtual environment image block.

5. The system of claim 1, wherein the communication circuitry is to communicate an identification of the requested at least one virtual environment image block to a second cluster manager to prompt the second cluster manager to prefetch the at least one virtual environment image block from the image registry.

6. The system of claim 1, wherein the communication circuitry is to communicate the processed at least one virtual environment image block to a second cluster manager for provision to a second worker node that is to execute the virtual environment.

7. The system of claim 1, wherein the communication circuitry is to encrypt the processed at least one virtual environment image block according to a communication protocol prior to communicating the processed at least one virtual environment image block to the worker node.

8. The system of claim 7, wherein the communication protocol is a Compute Express Link (CXL) protocol.

9. The system of claim 1, wherein processing the at least one virtual environment image block comprises decrypting the at least one virtual environment image block.

10. The system of claim 1, wherein processing the at least one virtual environment image block comprises decompressing the at least one virtual environment image block.

11. The system of claim 1, wherein processing the at least one virtual environment image block comprises performing cyclic redundancy check operations on the at least one virtual environment image block.

12. The system of claim 1, further comprising at least one computing system to:
calculate a score for the virtual environment and a plurality of prospective scores for the virtual environment at prospective locations; and
initiate movement of the virtual environment from the worker node to a different worker node based on a prospective score that is higher than the score.

13. The system of claim 12, wherein the score is based on characteristics of network traffic between the virtual environment and a plurality of other virtual environments as well as distance metrics between a current location of the virtual environment and locations of the plurality of other virtual environments.

14. The system of claim 13, wherein the plurality of prospective scores are based on the characteristics of network traffic between the virtual environment and the plurality of other virtual environments as well as distance metrics between the prospective locations for the virtual environment and the locations of the plurality of other virtual environments.

15. At least one non-transitory machine-readable storage medium having instructions stored thereon, wherein the instructions, when executed on a machine, cause the machine to:
send a request to an image registry for at least one virtual environment image block of an image for a virtual environment;
process the at least one virtual environment image block upon reception of the at least one virtual environment image block from the image registry; and
communicate the processed at least one virtual environment image block to a worker node that is to execute the virtual environment.

16. The at least one medium of claim 15, wherein the instructions, when executed on the machine, are to cause the machine to communicate the processed at least one virtual environment image block to a second worker node that is to execute the virtual environment.

17. The at least one medium of claim 15, wherein the request to the image registry is sent based on a list of images to be prefetched, wherein the list is generated by an orchestration manager.

18. The at least one medium of claim 15, wherein the request to the image registry is sent based on a request from the worker node for the at least one virtual environment image block.

19. A method comprising:
sending a request to an image registry for at least one virtual environment image block of an image for a virtual environment;
processing the at least one virtual environment image block upon reception of the at least one virtual environment image block from the image registry; and
communicating the processed at least one virtual environment image block to a worker node that is to execute the virtual environment.

20. The method of claim 19, further comprising communicating the processed at least one virtual environment image block to a second worker node that is to execute the virtual environment.
